(19) United States
(12) Patent Application Publication
(10) Pub. No.: US 2009/0114624 A1
(43) Pub. Date: May 7, 2009

(54) Support structure for welding backbar

(75) Inventor: Koji Ogoshi, Mie (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Minato-ku ,Tokyo (JP)

(21) Appl. No.: 11/919,231

(22) PCT Filed: Apr. 21, 2006
(86) PCT No.: PCT/JP2006/308914

§ 371 Date: Apr. 23, 2008

(30) Foreign Application Priority Data
Apr. 27, 2005 (JP) 2005-130051

(51) Int. Cl. B23K 11/11

(52) U.S. Cl. 219/86.25

(57) ABSTRACT

The present invention concerns a structure for supporting a welding backbar (13) to be used as an auxiliary electrode plate in a spot-welding operation. The structure includes a plurality of leaf springs (21, 22, 23) laminated on a bracket (27) fixed to a base (32). Each of the leaf springs is fixed at one end portion to the bracket by means of first bolts (26). The backbar (13) is fixed to the other end portions of the leaf springs (21, 22, 23) by means of second bolts (35).

### TECHNICAL FIELD

The present invention relates to an improved structure for supporting a welding backbar to be placed against a workpiece in a spot welding operation.

### BACKGROUND ART

If an electrode is applied directly to a workpiece in a spot welding operation, dints, impression and the like tend to be produced in an outer surface of the workpiece. Thus, in many cases, the electrode is applied to the outer surface of the workpiece, via a welding backbar functioning as a backing plate, to avoid the dints, impression and the like.

One example of a structure for supporting such a welding backbar is disclosed, for example, in JP-UM-3-116277 A, in which the backbar is fixed to a bracket via a resilient member. This welding backbar support structure will be described below with reference to FIG. 5 hereof.

Spot-welding gun device shown in FIG. 5 includes a gun arm 101, and a gun cylinder 102. Fixed spot electrode 103 is provided at the distal end of the gun arm 101, while a movable spot electrode 106 is provided at the distal end of a rod 104 that is in turn telescopically (or expandably/retractably) provided at an end of the gun cylinder 102. Bracket 107 is secured to the gun arm 101, a welding protecting metal plate 111 functioning as the welding backbar is fixed via a spring 108 to the bracket 107 between the fixed spot electrode 103 and the movable spot electrode 106.

The posture of the welding protecting metal plate 111 can be temporarily varied, via the above-mentioned spring 108, to extend along a workpiece (i.e., to generally conform to the contour or shape of the workpiece), in which case, however, it is necessary to press the workpiece against the plate 111 against the resilient force of the spring 108. Particularly, in cases where a plurality of welding protecting metal plates 111 are to be placed against a workpiece via a plurality of springs, the overall resilient force of the spring increases, so that the necessary force to press the workpiece against the welding protecting metal plate 111 also increases. Where a plurality of welding protecting metal plates 111 are formed into respective predetermined shapes for dedicated or exclusive use for a plurality of differently-shaped sections of a workpiece, the metal plates 111 can not be used any more when the workpiece has been replaced with another one different in shape from the previous workpiece.

### DISCLOSURE OF THE INVENTION

According to an aspect of the present invention, there is provided an improved structure for supporting a welding backbar to be used as an auxiliary electrode plate in a spot-welding operation, which comprises: a base; a bracket fixed to the base; and a plurality of leaf springs laminated on the bracket, each of the leaf springs being fixed at one end portion thereof to the bracket by means of a first bolt, each of the leaf springs having another end portion projecting beyond the bracket, the backbar being fixed to the other end portions of the leaf springs by means of a second bolt.

In the present invention, the backbar is fixed via the plurality of leaf springs laminated on the bracket, and thus, by loosening the first and second bolts, the posture of the backbar can be readily changed so as to extend generally along a shape of a workpiece. Then, by tightening the first and second bolts, the backbar can be held in the changed posture generally conforming to the shape of the workpiece.

Thus, even in a case where a plurality of the backbars are used for spot-welding a workpiece, there is no need for a great force for pressing the workpiece against the backbar against the resiliency of the leaf springs, so that the structure of the present invention can easily cause the backbar to extend along the workpiece. Further, because the structure of the present invention allows the posture of the backbar to be readily changed in conformity with the shape of the workpiece, the backbar can have an enhanced versatility.

Preferably, each of the leaf springs has bolt inserting holes formed therein for insertion therethrough the first and second bolts, each of the bolt inserting holes being greater in size than an outer diameter of a corresponding one of the first and second bolts, the plurality of leaf springs can be fixed in a posture or position tilted horizontally and/or vertically relative to a longitudinal direction of the bracket, and the backbar can be fixed in a posture or position tilted horizontally and/or vertically relative to a longitudinal direction of the plurality of leaf springs.

Because each of the bolt inserting is formed into a size greater than the outer diameter of a corresponding one of the first and second bolts, the leaf springs can be displaced relative to the bracket, and the backbar can be displaced relative to the leaf springs, so that degree of freedom with which to change the posture of the backbar in conformity with the shape of the workpiece can be even further enhanced.

The plurality of leaf springs are preferably three laminated leaf springs. The middle one of the three leaf springs functions as a strut and the other leaf springs can slide or twist relative to the middle leaf spring, so that the whole of these leaf springs can be readily formed into a desired or target shape. Once formed into the target shape, friction between the leaf springs can effectively prevent the shape of the whole of the leaf springs from changing easily. Thus, by loosening the first or second bolt, the backbar can be readily changed into a target posture, and, by tightening the first or second bolt, the backbar can be reliably maintained in the changed posture.

### BRIEF DESCRIPTION OF DRAWINGS

FIG. 1 is a side view showing a structure for supporting a welding backbar in accordance with a preferred embodiment of the present invention;

FIG. 2 is an exploded view of the welding backbar support structure shown in FIG. 1;

FIG. 3 is a plan view showing relationship among the backbar, leaf spring and bracket shown in FIG. 2;

FIG. 4A is a side view of the welding backbar support structure with the backbar in a vertically tilted posture;

FIG. 4B is a side view of the welding backbar support structure with the backbar in a three-dimensionally tilted posture;

FIG. 4C is a plan view of the welding backbar support structure with the backbar in a horizontally, two-dimensionally tilted posture; and

FIG. 5 is a side view of a spot-welding gun device equipped with a conventional welding backbar.

### BEST MODE FOR CARRYING OUT THE INVENTION

FIG. 1 is a side view showing a structure for supporting a welding backbar in accordance with a preferred embodiment of the present invention. As shown, the welding backbar support structure of the invention includes a first panel 11, and a second panel 12 overlappingly placed on the first panel 11. Welding backbar 13 has one surface 13a abutted against an outer or non-welding surface 11a of the first panel 11, a first electrode 14 is pressed against the other or outer surface 13b of the backbar 13, and a second electrode 16 is pressed against an outer or non-welding surface 12b of the second panel 12. The first and second panels 11 and 12, interposed between the first and second electrodes 14 and 16, are spot-welded together by energization of the first and second electrodes 14 and 16. Reference numeral 11b indicates the other or welding surface of the first panel 11, and 12a indicates a welding surface of the second panel 12.

The backbar 13 is an integrally-formed member, which comprises a workpiece abutting section 13c having the above-mentioned one surface 13a and a mounting section 13d mounted to one end portion of a laminated spring 24 including a plurality of (three in this case) of leaf springs 21, 22 and 23.

Although the leaf springs 21, 22 and 23 each have the same shape, they are indicated by different reference numerals just for the purpose of distinguishing among them. The laminated spring 24 is fixed at its other end portion to a bracket 27 by means of first bolts 26, and the bracket 27 is in turn fixed to a base 32 by means of first bolts 31.

Further, the backbar 13 is fixed to the laminated spring 24 by means of second bolts 35 and a nut member 36 positioned on the underside of the laminated spring 24 in screwing engagement with the second bolts 35.

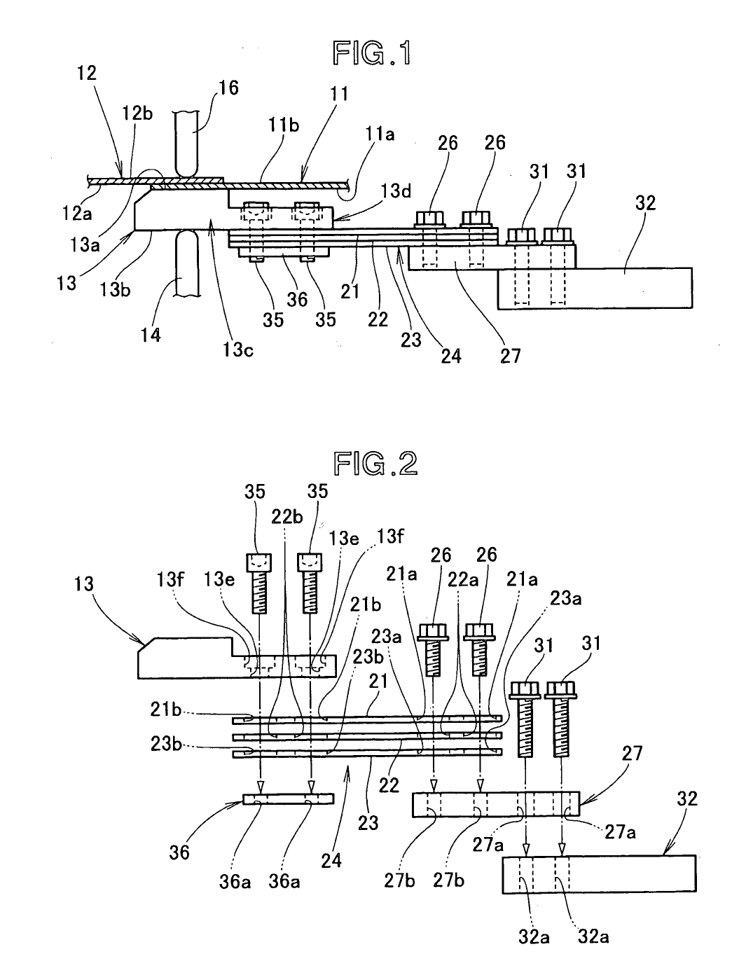

FIG. 2 is an exploded view of the welding backbar support structure shown in FIG. 1. The base 32 has internal threads 32a formed therein, and the bracket 27 has bolt inserting holes 27a formed therein. The bracket 27 is secured to the base 32 with the bolts 31 inserted through the bolt inserting holes 27a and screwed into the internal threads 32a of the base 32.

The bracket 27 also has internal threads 27b, and the leaf springs 21, 22 and 23 each have bolt inserting holes 21a, 22a or 23a. The laminated spring 24 is secured to the bracket 27 with the first bolts 26 inserted through the bolt inserting holes 21a, 22a and 23a and screwed into the internal threads 27b of the bracket 27. Namely, the plurality of leaf springs 21, 22 and 23 are fixed at their respective end portions to the bracket 27 and have their respective other end portions projecting beyond the bracket 27.

Further, the nut member 36 has internal threads 36a, the leaf springs 21, 22 and 23 each have bolt inserting holes 21b, 22b or 23b, and the backbar 13 has bolt inserting holes 13e and counterbores 13f at respective one end portions of the bolt inserting holes 13e. The backbar 13 is secured to the laminated spring 24 with the second bolts 35 inserted through the bolt inserting holes 21b, 22b and 23b and screwed into the internal threads 36a of the nut member 136.

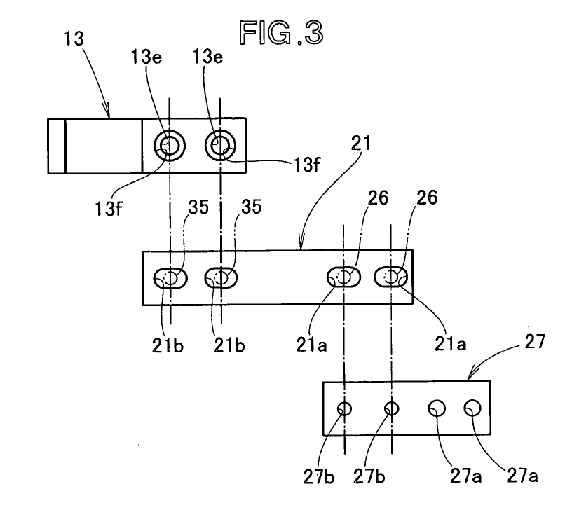

FIG. 3 is a plan view explanatory of relationship among the backbar 13, leaf spring 21 and bracket 27 shown in FIG. 2. The bolt inserting holes 21a and 21b formed in the leaf spring 21 are of the same elongated shape and each have an inner diameter greater than an outer diameter of a corresponding one of the first and second bolts 26 and 35; more specifically, each of the bolt inserting holes 21a and 21b has a major axis along the length (longitudinal direction) of the leaf spring 21, and a minor axis perpendicular to the length of the leaf spring 21. Thus, the first and second bolts 26 and 35 are movable in the corresponding elongated bolt inserting holes 21a and 21b.

The following paragraphs describe behavior of the welding backbar support structure constructed in the above-described manner.

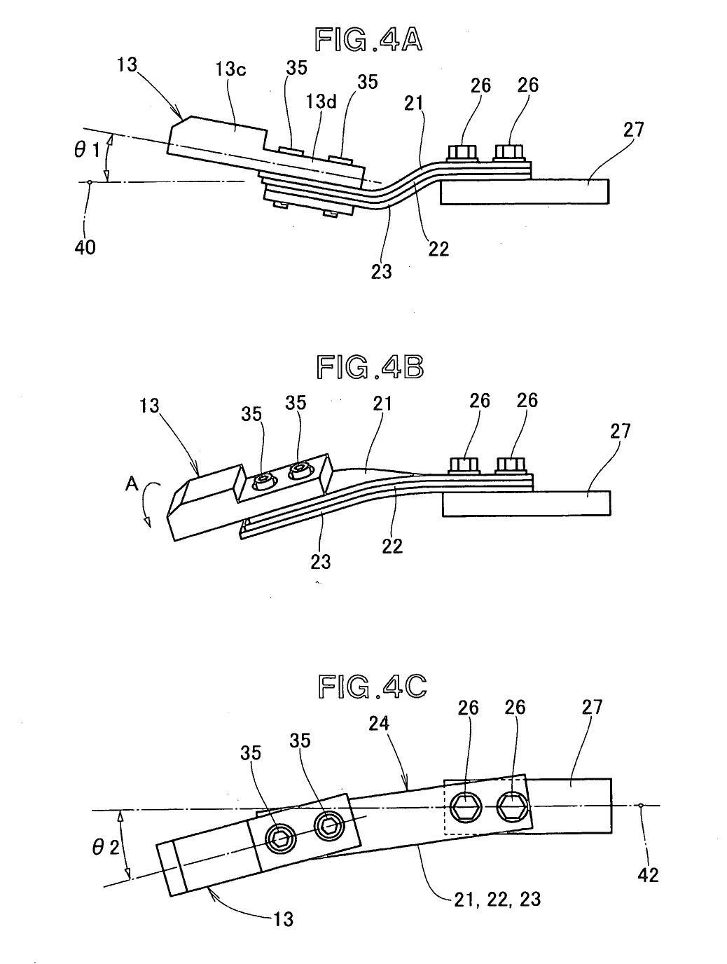

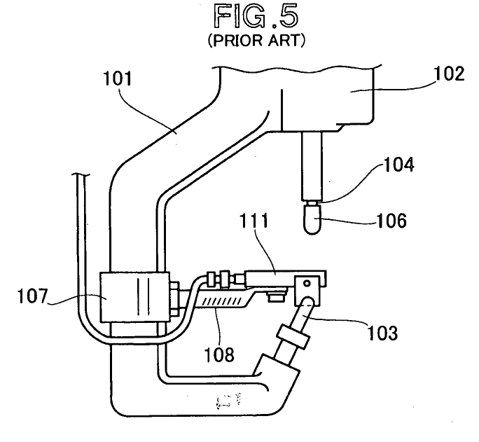

FIG. 4A is a side view of the welding backbar support structure of the invention. In FIG. 4A, the backbar 13 is shown as held in a position or posture changed or tilted vertically, from the posture of FIG. 1, at an angle θ 1 relative to a horizontal line 40. To achieve this tilted posture, the second bolts 35 are loosened, and the workpiece abutting section 13c of the backbar 13 is raised upward with the mounting section 13d lowered. Then, the second bolts 35 are tightened with the workpiece abutting section 13c kept in the raised position and the mounting section 13d kept in the lowered position. Namely, FIG. 4A shows the backbar 13 in a posture having been tilted two-dimensionally in the vertical direction. In the state of FIG. 4A, the topmost and bottommost leaf springs 21 and 23 have been displaced (or slid) in the longitudinal direction relative to the middle leaf spring 22.

In FIG. 4B, the backbar 13 is shown as held in a position or posture twisted relative to the bracket 27. To achieve this twisted posture, the second bolts 35 are loosened with the leaf springs 21, 22 and 23 fixed to the bracket 27 by means of the first bolts 26, and then the backbar 13 is twisted in a direction of arrow A. After that, the second bolts 35 are tightened with the leaf springs 21, 22 and 23 fixed to the bracket 27 and the backbar 13 twisted in the direction of arrow A. Namely, FIG. 4B shows the backbar 13 in a posture having been tilted three-dimensionally. In the state of FIG. 4B, the topmost and bottommost leaf springs 21 and 23 have been twisted and displaced (or slid) in the longitudinal direction relative to the middle leaf spring 22.

Whereas, in the illustrated examples of FIGS. 4A and 4B, the second bolts 35 are first loosened with the first bolts 26 kept tightened and then tightened after completion of the posture change of the backbar 13, the present invention is not so limited. For example, the first bolts 26 may be first loosened with the second bolts 35 kept tightened and then tightened after completion of the posture change of the backbar 13.

FIG. 4C is a plan view of the welding backbar support structure of the invention. In FIG. 4C, the backbar 13 is shown as held in a posture tilted at an angle θ 2 relative to a center line 42. To achieve this tilted posture, the laminated spring 24 is secured to the bracket 27 in a tilted relation to the center line 42 of the bracket 27 utilizing gaps between surfaces of the leaf springs 21, 22, 23 defining the bolt inserting holes 21a, 21b, 22a, 22b, 23a, 23b (see FIG. 2) and the first and second bolts 26 and 35. Namely, FIG. 4C shows the backbar 13 in a posture tilted two-dimensionally in the horizontal direction.

Further, the postures illustrated in FIGS. 4A-4C may be used in combination.

With the above-described arrangements, the plurality of leaf springs 21-23 can be fixed in a position or posture tilted horizontally and/or vertically relative to the longitudinal direction of the bracket 27, and the welding backbar 13 can be fixed in a position or posture tilted horizontally and/or vertically relative to the longitudinal direction of the bracket 27.

With the welding backbar support structure of the present invention, it is possible to readily make the two-dimensional and three-dimensional posture changes of the backbar 13 as illustrated in FIGS. 4A-4C. Because the working surface of the backbar 13 can be easily caused to conform to the shape of the workpiece by virtue of any of such posture changes, the shape of the backbar 13 may be modified only when the wear of the backbar 13 has increased to a considerable degree, so that the number of the shape modifications of the backbar 13 can be significantly reduced. Further, even in the case where spot-welding is performed using a plurality of the backbars 13 in corresponding relation to differently-shaped sections of a workpiece, the necessary setup time can be minimized because the support structure of the present invention allows the respective postures of the backbars 13 to conform to the respective shapes of the sections of the workpiece.

Further, the support structure of the present invention can hold the backbar 13 in any changed or tilted posture as noted above, and thus, in the case where the backbar 13 is supported via a single leaf spring, for example, the support structure of the present invention can eliminate a need for pressing, with a great force, the workpiece against the backbar 13 to thereby forcedly cause the backbar 13 to extend along the workpiece.

Whereas each of the bolt inserting holes 21a, 22a, 23a, 21b, 22b, 23b in the preferred embodiment has been described above as having an elongated shape as shown in FIG. 2 or 3, each of these inserting holes may be a circular hole greater in diameter than the outer diameter of a corresponding one of the first and second bolts 26 and 35.

### INDUSTRIAL APPLICABILITY

The welding backbar support structure of the present invention is particularly suited for use in spot-welding using a plurality of backbars.

1. A structure for supporting a welding backbar to be used as an auxiliary electrode plate in a spot-welding operation, said structure comprising:
a base;
a bracket fixed to said base; and
a plurality of leaf springs laminated on said bracket, each of said leaf springs being fixed at one end portion thereof to said bracket by means of a first bolt, each of said leaf springs having another end portion projecting beyond said bracket, said backbar being fixed to the other end portions of said leaf springs by means of a second bolt.

2. A structure according to claim 1 wherein each of said leaf springs has bolt inserting holes formed therein for insertion therethrough the first and second bolts, each of the bolt inserting holes being greater in size than an outer diameter of a corresponding one of said first and second bolts,
said plurality of leaf springs can be fixed in a position tilted horizontally and/or vertically relative to a longitudinal direction of said bracket, and
said backbar can be fixed in a position tilted horizontally and/or vertically relative to a longitudinal direction of said plurality of leaf springs.

3. A structure according to claim 1 wherein said plurality of leaf springs are three laminated leaf springs.
